(19) United States
(12) Patent Application Publication
(10) Pub. No.: US 2003/0116380 A1
(43) Pub. Date: Jun. 26, 2003

(54) Wind chute escape system

(76) Inventors: Xin-Rui Xia, Durham, NC (US); Xiang Q. Kong, Durham, NC (US)

Correspondence Address: XIN-RUI XIA, 1011 SOUTH MINERAL SPRINGS RD., DURHAM, NC, 27703, US

(21) Appl. No.: 09/683,419

(22) Filed: Dec. 26, 2001

(51) Int. Cl. A62B 1/20

(52) U.S. Cl. 182/48

(57) ABSTRACT

The present invention is a wind chute escape system using a wind pressure to control the descending speed of a person inside a wind chute. A strong landing pressure produced by a landing blower is used to decelerate the descending body to a safe landing speed. The wind pressure inside the wind chute is produced and controlled by a wind blower and the landing blower or by one of them. There are mainly two forces acted on the descending body inside the wind chute, the downward gravity and the upward wind pressure. The balance of theses two forces determines the descending speed of the escapee. Since the wind pressure inside the wind chute is under control, the descending body can be control to a desired speed. Since the wind pressure loss is small in large wind chutes of 1 to 5 feet. in diameter, and the wind pressure transfers inside the wind chute in a speed of sound, this wind chute escape system can be used for high-rise buildings or skyscrapers of hundreds, even thousands of feet high. One triple chute system could evacuate one thousand escapees per hour. Two simplified embodiments of the present invention are also disclosed.

### BACKGROUND OF INVENTION

1. Field of the Invention

The present invention relates to an emergency escape system from high-rise buildings, and more specifically to a wind chute escape system using a wind pressure produced into the wind chute to control the descending speed of the escapees who using it.

2. Description of the Prior Art

Many thousands of people were killed by the terrorist attacks on the World Trade Center on Sep. 11, 2001. Hundreds of firemen and police officers rescuing the people were also killed inside when the twin towers collapsed. Hundreds of fire fighting trucks and ambulances were queuing outside the World Trade Center. There was no any high-rise rescue effort tried to save the trapped people even though the twin towers had stood almost an hour after the planes crashed into them.

Until now there is no effective measure for rescuing many thousands of people from high-rise buildings and skyscrapers in a limited time. Helicopter rescue is the only high-rise rescue technique developed for skyscrapers, which can at most save 16 people at a trip.

In U.S. patents many prior inventions devote to escape systems from high-rise buildings in emergency situations. Chute escape devices are specially attractive because of their obvious safety feature. Different kinds of chute escape systems have been tried. The key issue is how to retard the descending speed of the escapee inside the chute.

Discrete elastic restrictions at successive vertical levels are used to retard the descending speed of the escapee in U.S. Pat. Nos. 386,253; 3,348,630; 3,580,358; 4,339,019; 4,099,595 and 4,099,596. Flexible tubular devices which elastic only in transverse and circumferential direction are used to slow the descending speed of the escapee in U.S. Pat. Nos. 3,973,644; 3,977,495; 5,320,195; 5,871,066 and 6,098,747. U.S. Pat. No. 4,681,186 discloses a chute having a friction-creating material to permeating an individual descending in the chute and contacting the panel to have his or her speed of descent retarded.

Ropes and endless cables inside the chutes are used to provide a mechanical braking in U.S. Pat. Nos. 672,623; 2,101,284; 4,531,611; 4,595,074. U.S. Pat. Nos. 4,398,621; 4,580,659 and 4,582,166 disclose escape chutes with mesh tubes for the escapee hands engaging the mesh to slow his or her descending speed. U.S. Pat. No. 5,115,885 discloses a clock-like mechanical mean to retard the descending speed.

Increased sliding path is used to retard the descending speed by utilizing a zigzag passage in U.S. Pat. No. 3,994,366; or spiral sliding passages in U.S. Pat. Nos. 3,819,011; 4,167,224; 4,240,520.

The combination of escape chutes and crane-like vehicles without special means to retard the descending speed are disclosed in U.S. Pat. Nos. 3,027,966; 4,050,542; 4,577,725 and 4,650,034. Other chutes without special means to retard the descending speed are disclosed in U.S. Pat. Nos. 935,447; 2,270,437; 4,162,717; 4,444,290 and 4,778,031.

Fluid dynamic means are rarely used in the prior arts to control the descending speed. U.S. Pat. No. 4,122,934 discloses a double flexible tubes filled with a pressurized fluid in the between and the fluid pressure is adjusted to decelerate the descending bodies. U.S. Pat. No. 4,372,423 discloses a escape chute which consists a tube, a water tank located at the bottom of the tube and a parachute inside the tube for retarding the velocity of the descending person. U.S. Pat. No. 4,997,060 discloses an apparatus for lowering a passenger-carrying gondola from a high-rise building including a vertical shaft or chute having vent openings at its upper end and lower end and the gondola is decelerated by the air pressure under it and the vacuum above it.

There is no effective measure to control the descending speed in these prior arts. Thus, these escape chutes can only be used for low-rise building or limited high-rise buildings. It is impossible to use these chutes for escaping from skyscrapers and very high buildings.

Airodium uses a vertical wind tunnel to let people fly in a confined space. If a wind pressure is created in a long tubular chute, a person can also fly inside the chute. If the wind pressure is controlled properly a person can descend from high level to lower level in a controlled descending speed. This strategy can be used for high-rise building escape in emergency situations. Since the loss of the wind pressure in the chute is very small and the wind pressure transfers in a speed of sound, this wind chute can be used for emergency escape from high-rise buildings and skyscrapers of hundreds, even thousands of feet high. This is the principle of the present invention.

### SUMMARY OF INVENTION

The present invention is a wind chute escape system comprising a chute entrance, a wind chute, a wind blower, a landing blower, a rotating door, an automatic control system and setup facilities. The chute entrance is setup or pre-setup on an escaping floor level of a building requiring emergency evacuation. One end of the wind chute is connected to the chute entrance and the other end is connected to the wind blower. The wind blower and the landing blower in a landing unit located on a safe ground beside the building, produce a wind flow up to the chute entrance along the wind chute. The wind pressure of the wind flow inside the wind chute is used to control the descending body to a desired speed. The people requiring emergency evacuation enter the wind chute, descend inside the wind chute in the controlled speed, decelerated to a safe landing speed by a landing pressure produced by the landing blower and exit to the safe ground.

One escapee enters the wind chute from the chute entrance and descends in the wind chute at a predetermined safe speed. The automatic control system detects the descending speed of this escapee, and adjusts the wind pressure inside the wind chute to control the descending speed of the escapee. There are mainly two forces acted on the body of the escapee inside the wind chute, the downward gravity and the upward wind pressure. The balance of these two forces determines the descending speed of the escapee. Since the wind pressure is under control, the descending body inside the wind chute can be controlled to a desired speed.

After the first escapee falls to a predetermined distance, next escapee can enter the wind chute. Since the descending speed is under control, it may take only few seconds to permit next escapee to enter the wind chute. One after one, people on the emergency floor can be quickly evacuated to the safe ground. For instance, it takes 9 seconds to permit next escapee to enter the wind chute, one wind chute could evacuate 400 escapees per hour.

Since the loss of the wind pressure is very small in large tubes of 1 to 5 feet in diameter, and the wind pressure transfers inside the wind chute in a speed of sound, the wind chute escape system can be used for high-rise buildings and skyscrapers of hundreds, even thousands of feet high. The only limitations are the length of the wind chute and the height it can be set up.

Four setup approaches are preferred: helicopter assisted setup, spool assisted setup, VTOL assisted setup and build-in setup. The helicopter assisted setup uses a helicopter to pull the chute entrance together with the wind chute from a vehicle containing the wind chute system on the ground to the emergency floor level. The spool assisted setup has a spool and a chute entrance preinstalled at an escape floor level; and uses the spool and a cable to pull the wind chute from the wind chute system on the ground to the escape floor level. VTOL assisted setup has the chute entrance built-in a vertical taking off and landing device (VTOL), which pulls the wind chute to the emergency floor level from the vehicle containing the wind chute system. build-in setup is a wind chute system permanently built inside or outside of the building, in which the wind chutes are built as high as the building with a series of chute entrances located on several escape floor levels, and the landing unit is located on the ground level.

Lay-flat wind chutes are used in the potable wind chute escape systems, such as, the helicopter assisted setup, the spool assisted setup and the VTOL assisted setup. Rigid wind chutes are preferred for the build-in setup. One setup can have more than one wind chute, such as, double chutes, triple chutes or multiple chutes, depending on the evacuation rate desired. The wind chutes in a multiple chute system can have same diameter or different diameters, while a setup with different chute diameters is preferred if the body sizes of the occupants are considerably different. The working principle of each wind chute in a multiple chute system follows the same working principle as a single wind chute.

A simplified embodiment of the present invention comprises only one landing blower, a chute entrance, a wind chute, a rotating door and an automatic control system, in which the landing blower produces both of the wind pressure inside the wind chute to control the descending speed and the wind pressure inside the landing blower to decelerate the descending body to a safe landing speed. The simplest embodiment of the present invention comprises only one landing blower, a chute entrance and a wind chute. It can be used for emergency evacuation from low-rise buildings or limited high-rise buildings.

These and other objects of the invention will be fully understood from the following more detailed description by referencing to the drawings.

### BRIEF DESCRIPTION OF DRAWINGS

The description refers to the accompanying drawings in which like reference characters refer to like parts throughout the several setups.

FIG. 1 shows the wind chute escape system comprising a chute entrance, a wind chute, a wind blower, a landing blower, a rotating door and an automatic control system, as well as its working principle.

FIG. 2 shows the helicopter assisted setup.

FIG. 3 shows the spool assisted setup.

FIG. 4 shows the VTOL assisted setup.

FIG. 5 shows the build-in setup.

FIG. 6 shows the triple chute system.

FIG. 7 shows the air flow analysis of the wind chute escape system.

FIG. 8 shows a simplified embodiment of the wind chute escape system with a single wind blower.

FIG. 9 shows the simplest embodiment of the wind chute escape system

### DETAILED DESCRIPTION

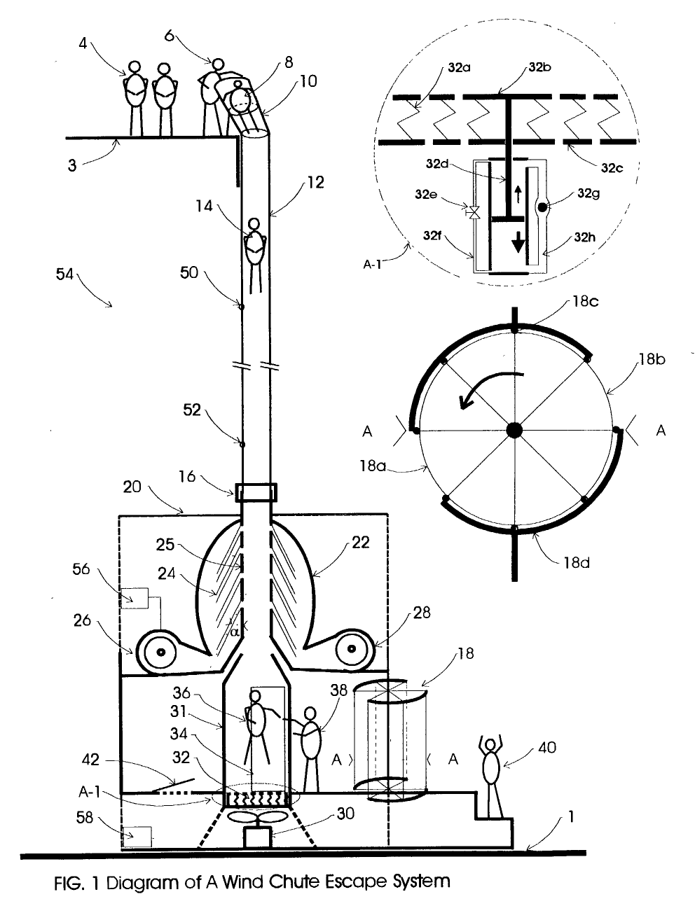

Referring now more specifically to FIG. 1 there is shown a preferred form of the escape system of the present invention. In this embodiment, a chute entrance 10 is setup or pre-setup at an emergency floor level 3 located on the top or at the window or escape opening of the building. One end of a wind chute 12 is connected to the chute entrance. The other end is connected to a wind blower 22 in a landing unit 20. The landing unit consists of the wind blower 22, a landing blower 31, an exit opening 34, a rotating door 18 and an automatic control system 56, 58.

The wind blower 22 comprises of a wind blowing fan 26 and a spare wind blowing fan 28, preferably centrifugal fans, and a series of jet pipes 24 attached into a center tube 25. When the wind blowing fan is working an air flow will jet into the center tube through the jet pipes, which are positioned in an angle (α) to the center tube to produce a maximum upward wind pressure. The center tube is about the same diameter as the wind chute. The number and size of the jet pipes are governed by two requirements: the air flow rate and the air pressure jetting into the center tube. The air flow rate must be strong enough to create a wind pressure inside the wind chute to control the descending speed of the escapee. The air pressure jetting into the center tube must be mild enough not to injure the escapees when passing through the center tube. The wind blower, the center tube and jet pipes are made of plastic and metal materials by molding or welding. In the wind blower more than one wind blowing fan can be used side by side to increase the total airflow rate or extra operational security, or in serial to increase the wind pressure required.

The landing blower 31 comprises of a landing fan 30, preferably an axial fan, a landing pad 32 and an exit opening 34. The landing fan produces an upward landing pressure to decelerate the descending body to a safe landing speed inside the landing blower. Another function of the landing fan is to produce a wind pressure into the wind chute work together with the wind pressure produced by the wind blower 22 to create an upward wind pressure inside the wind chute to control the descending speed of the escapees. In the landing blower more than one landing fan can be used side by side to increase the total airflow rate or extra operational security, or in serial to increase the wind pressure required.

The landing pad is a spring mesh which provides softer landing with little resistance to the wind flow produced by the landing fan as shown in A-1 in FIG. 1. The landing pad consists of a series of springs 32a, a top mesh 32b, a bottom mesh 32c and a vibration reducer apparatus 32d. The top mesh is vertically moveable with the springs to provide the softer landing. The bottom mesh is fixed in position. The vibration reducer apparatus can be a device like a car suspension or a device as illustrated in A-1. The piston shaft 32d is fixed to the top mesh 32b. The piston cylinder and a thin channeling tube 32f and a thick channeling tube 32h are filled with a hydraulic fluid. When the top mesh moves downward, the piston produces little resistance to the top mesh by a means that a stopper 32g is open and the fluid flows through the thick tube 32h. When the top mesh moves upward, its speed is controlled by the piston by a means that the stopper 32g is closed, the fluid can only flow through the thin tube 32f with a flow rate adjusted by valve 32e. Thus, the springs will provide softer landing, but will not bounce up.

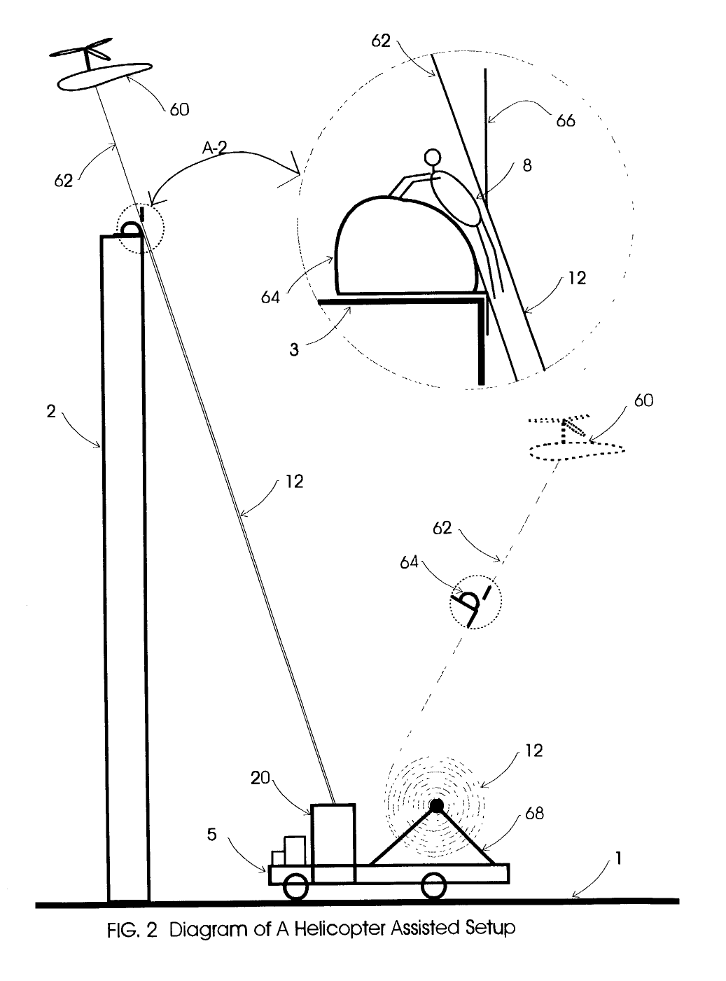

The chute entrance 10 is made of plastic and metal materials. Its design should be strong, simple and smooth. The chute entrance has three functions: one is to let the escapee enter the wind chute easily and quickly, second is to provide a measure to fasten itself to the emergency floor easily and quickly, third is to prevent people from falling out of the edge of the building. The chute entrance can be a regular sliding type as shown in FIG. 1. It is preferred to be a facing-down sliding type as shown in A-2, FIG. 2, in which the escapee 8 is facing-down, holding the sliding 64 and ready to enter the wind chute 12. The advantage of this sliding is to let the body of the escapee gradually enter the strong wind flow, which may reduce the fear of the escapee. The chute entrance must provide a solid safe guard to prevent people from falling out of the edge of the building and to reduce the fear of the escapees.

The rotating door 18 is installed on the outer shell of the landing unit 20. There are two large walls 18d surround the rotating door to provide air tight and withhold a static pressure inside the landing unit 20. There are also heavy duty air seals 18c around the rotating door to reduce air loss through the door and keep the static pressure steady inside the landing unit. The static pressure is controlled by an air releaser 42 by releasing an airflow back to the landing fan or to the atmosphere outside. When the escapee 36 reaches the landing pad, he enters the rotating door at 18a and exit the landing unit at 18b to the safe ground 1 .

The wind blower 22 is located in the top section of the landing unit 20, where air intake holes and filters for the wind blowing fan are located on the outer shell of the landing unit. The rotating door 18 is located in the middle section of the landing unit, which withhold a static wind pressure inside the landing unit. An air releaser 42 is used to control the static pressure by releasing an airflow back to the landing fan 30, or to the outside atmosphere. The bottom section has air intake holes and filters for the landing fan 30.

In an emergency situation people 4 run to the chute entrance 10 to escape. The wind chute escape system is setup as described in FIG. 1, the wind blower 22 and the landing blower 31 are started to produce a wind flow into the wind chute. The wind flow is transferring from the landing unit 20 up to the chute entrance 10 along the wind chute 12. There will be a strong wind blowing out of the chute entrance located on the emergency floor level. When the wind pressure inside the wind chute reaches a predetermined safe strength, the whole system is ready for the people to escape through the wind chute.

One escapee 8 on the chute entrance 10 slides into the wind chute 12, preferably helped by a rescuer 6. In the wind chute there are mainly two forces acted on the body of the escapee 14, the downward gravity and the upward wind pressure. The balance of these two forces determines the descending speed of the escapee. Since the wind pressure is under control, the descending speed is also under control. The automatic control system detects the descending speed of the escapee, and controls the upward wind pressure inside the wind chute to control the descending body to a desired speed.

After the first escapee falls to a predetermined distance, next escapee can enter the wind chute. Since the descending speed is under control, it may take only few seconds to permit next escapee to enter the wind chute. Thus, there may be more than one escapee descending inside the wind chute at same time. One after one, people on the emergency floor level can be evacuated very quickly to the safe ground. For instance, it takes 9 seconds to permit next escapee to enter the wind chute, one wind chute could evacuate 400 escapees per hour.

Since the loss of the wind pressure is small in the large tubes of 1 to 5 feet in diameter, and the wind pressure transfers inside the wind chute in a speed of sound, this wind chute escape system can be used for high-rise buildings and skyscrapers of hundreds, even thousands of feet high. Since the wind pressure transfers along the wind chute, the wind chute can be placed in any angle to the building, which permits the landing unit on the ground to be positioned at a safe location beside the building. The only limitations are the length of the wind chute and the height it can be set up.

Four setup approaches are preferred: helicopter assisted setup, spool assisted setup, VTOL assisted setup and build-in setup.

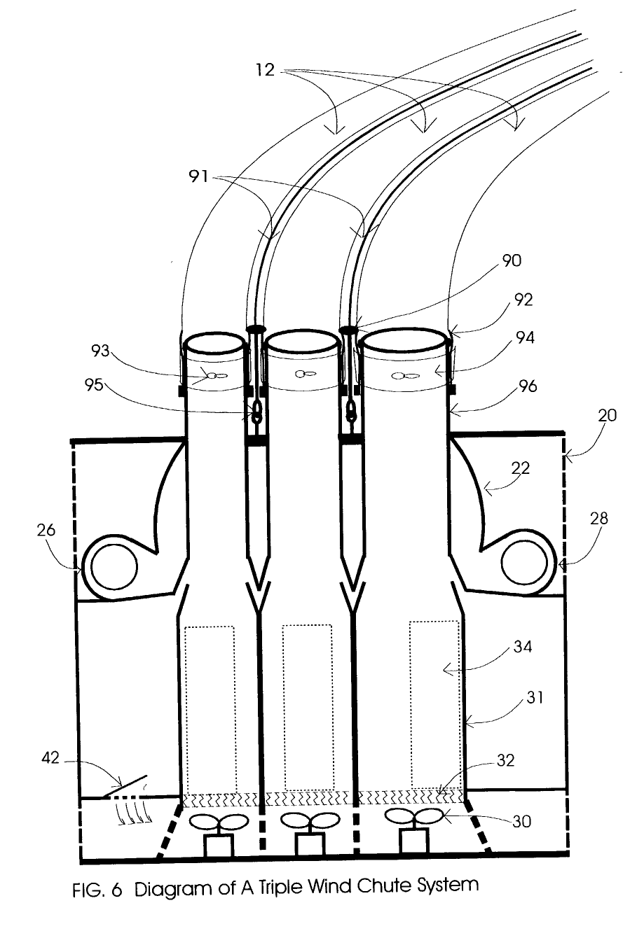

FIG. 2 illustrates the helicopter assisted setup. The landing unit 20 is installed on a truck 5. There is a big spool-like frame 68 to store the wind chute 12 and chute entrance 64 on the truck. The wind chute used in the helicopter assisted setup is a lay-flat tube made of heavy duty fabrics or canvas as described more detail in FIG. 6.

In an emergency situation the truck 5 is positioned at a safe position beside the building 2. A helicopter 60 uses a long cable 62 to pick up the chute entrance 64 together with the wind chute 12 from the truck, and lifts the chute entrance to the emergency floor level 3. The chute entrance is fastened quickly to the emergency floor level, and at the same time the other end of the wind chute is connected to the landing unit 20 on the truck. When the wind blower and landing blower are started to produce a wind flow into the wind chute, the lay-flat wind chute will be inflated under the wind pressure. The wind flow is transferring from the landing unit 20 up to the chute entrance 64 along the wind chute 12. There will be a strong wind blowing out of the chute entrance located on the emergency floor level. When the wind pressure inside the wind chute reaches a predetermined safe strength, the whole system is ready for the people to escape through the wind chute as described in FIG. 1.

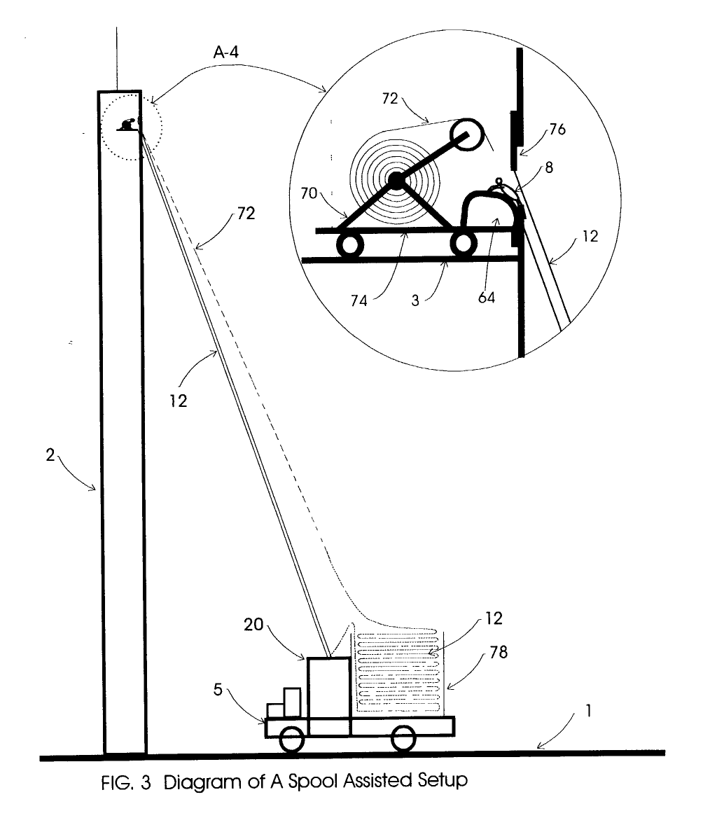

FIG. 3 illustrates the spool assisted setup. The landing unit 20 and a wind chute holder 78 are installed on a movable platform or truck 5. The lay-flat wind chute 12 is pre-connected to the landing unit and zigzag stored in the wind chute holder. A movable cart 74 containing the chute entrance 64 and a spool 70 is positioned at the escape opening 76 at the escape floor level 3. In an emergency situation the spool and a cable 72 are used to pull the wind chute from the wind chute holder to the chute entrance. After the wind chute is connected to the chute entrance, and the wind blower and the landing blower are started to produce a wind flow into the wind chute, the whole system is ready for the people to escape through the wind chute as described in FIG. 1.

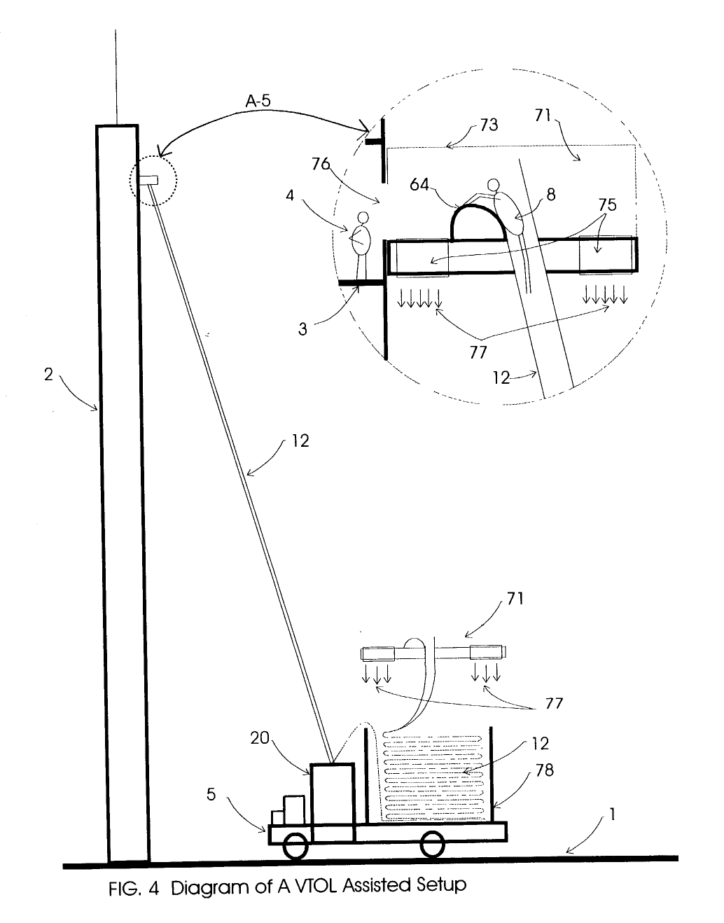

FIG. 4 illustrates the VTOL assisted setup. A complete wind chute escape system is installed on a truck 5, which comprises the landing unit 20, the lay-flat wind chute 12 stored in the wind chute holder 78 and the VTOL device 71 . The chute entrance 64 is built-in the VTOL device. The lay-flat wind chute is zigzag stored in the wind chute holder. One end of the wind chute is connected to the chute entrance in the VTOL device, and the other end is connected to the landing unit. In an emergency situation the truck 5 is positioned beside the building 2, the VTOL device takes off with its ducted fans 75 from the truck, pulls the wind chute 12, and flies to the emergency floor level 3, which can be the top or the window or escape opening of the building. The VTOL device provides a mean to hold in position to the floor level as shown in A-5, FIG. 4. When the landing unit is started to produce a wind flow into the wind chute, and the system is ready for the people to escape, escapees get on the VTOL device 71 from the escape opening 76, enter the wind chute 12 through the chute entrance 64 and descend to the safe ground as described in FIG. 1.

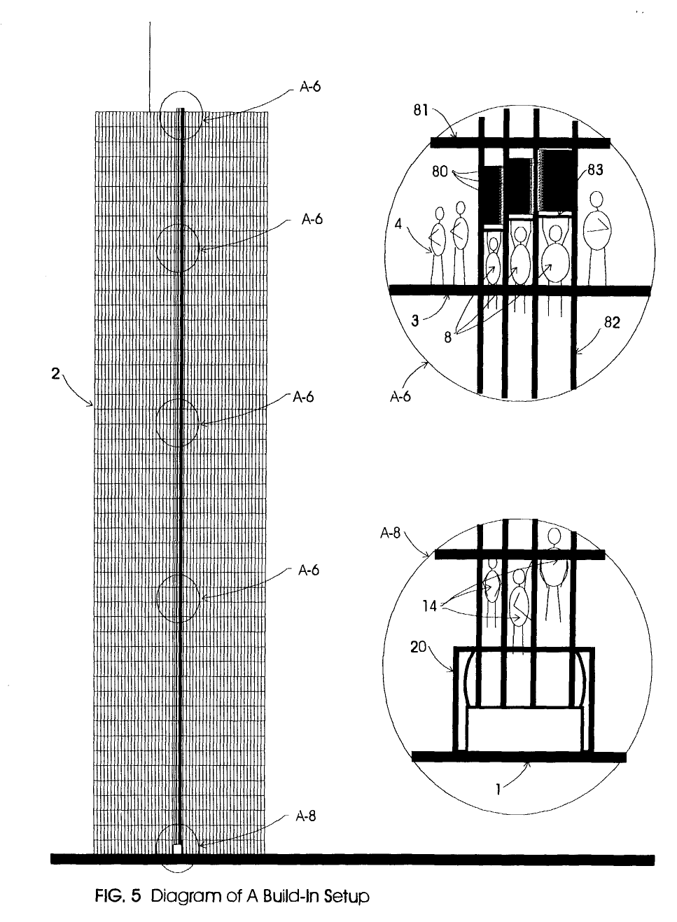

FIG. 5 illustrates the build-in setup. A complete wind chute escape system is built permanently inside or outside of the building. The landing unit 20 is located on the ground level 7 as shown in A-8, FIG. 5. The wind chutes are built as high as the building with a series of chute entrances 81 located at several floor levels as shown in A-6, FIG. 5. The wind chutes are preferred to be rigid tubes 82 made of plastic and metal materials. One set of wind chutes can devoted to only one escape level, or one set of wind chutes can be shared by different escape floor levels, in which the chute entrances must have doors 80 to provide air seal when the entrance is not used. An automatic door control system should be used to prevent the door from opening while somebody descending above this door level. The chute entrance can be a regular sliding as shown in FIG. 1, a facing-down sliding as shown in FIG. 2, or simply holding bars 83 as shown in A-6, FIG. 5.

The build-in setup has several advantages, for instance, it is ready to be deployed at anytime; occupants can practice with the wind chute escape system while not in emergency situations; it also can send occupants from a low level to a higher level because the wind chute can be made stronger; and it even can be used as an alternation of elevators or as an amusement device.

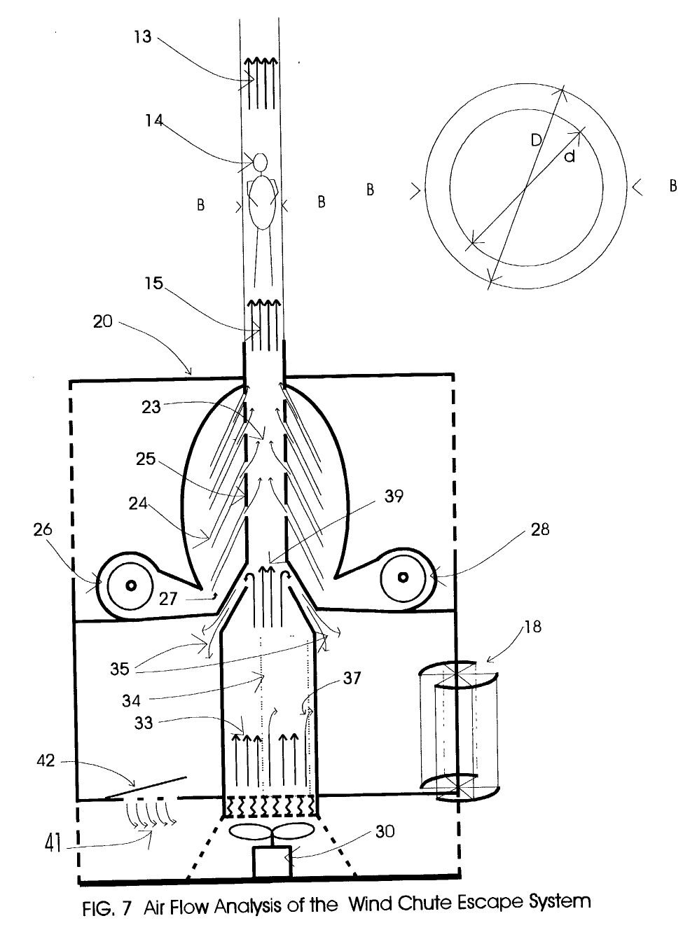

FIG. 6 shows a triple chute system with lay-flat wind chutes. One setup can have more than one wind chute, such as, double chutes, triple chutes or multiple chutes, depending on the evacuation rate desired. The wind chutes in a multiple chute system can have same diameter or different diameters, while setup with different chute diameters is preferred if the body sizes of the occupants are considerably different, for instance, children and adults, thin occupants and fat occupants. The diameter of the wind chute should be larger than the maximum body diameters of the escapees who using it as shown in FIG. 7. For instance, if the maximum body diameter of the escapees is 2.5 feet, the diameter of the wind chute should be 3 feet or more. The wind chute can not have any escapee blocked inside at any circumstance. To make the diameter of the chute entrance a little bit smaller than the diameter of the wind chute is an effective measure to prevent the escapees from blocking the wind chute. On the other hand, the diameter of the wind chute is limited by the power of the wind blowers and the convenience of handling the long wind chute . The working principle of a single chute is given in FIG. 1. In fact, each wind chute in a multiple chute system follows the same working principle as the single chute described in FIG. 1 and more detailed in FIG. 7.

The lay-flat wind chutes are used in potable wind chute escape systems, such as, the helicopter assisted setup (FIG. 2), the spool assisted setup (FIG. 3) and the VTOL assisted setup (FIG. 4). The lay-flat wind chute is made of heavy duty fabrics or canvas, which will provide strength exceeding safety requirements to withhold the wind pressure created inside the wind chute. The inside of the wind chute is coated with a polymer coating to provide air seal. Since the escapee descending inside of the wind chute is in a flying mode, there is no heavy friction between the body of the escapee and the wind chute. The inside surface of the wind chute can be smooth or coarse. An escapee can even touch the inside surface of the wind chute with his hands or body to gain extra retardation or acceleration. The outside of the wind chute should provide high mechanical strength, fire resistance and heat resistance. The multiple wind chutes are preferred to be reinforced with strong flexible cables of metal fibers or polymer fibers, which can provide strength exceeding the safety requirements to withhold the weight of the wind chute, the weight of the escapees descending in the wind chutes and the force applied by the setup facility.

The wind chute can be made in different lengths for different rescue heights. It is preferred to make the wind chutes connectable from one to another, so that different rescue heights can be simply accomplished by connecting more wind chutes together. A flexible heavy duty zipper type connection can be used for the wind chute connection, as commonly used for the lay-flat duct connection in the mining ventilation. A male-female connection with an outside fasten band can also be used for the wind chute connection. All the connections between the chute entrance and wind chute, the wind chute and wind blower and the wind chutes connection each other, must be air seal and strong, not to reduce the total strength of the wind chute as a whole.

The lay-flat wind chute can be stored in a spool-like frame as shown in FIG. 2. Its advantage is easy to handle the long lay-flat wind chute while its disadvantage is that the wind chutes can not be pre-connected to the wind blower. The wind chute can also be zigzag stored in a big box, which has the advantage that the wind chutes can be pre-connected to the wind blower as shown in FIG. 3. The potable wind chute escape system is preferred to be installed on a truck, with which power required for the wind blowers can be self supplied, and quick respond to an emergency rescue is possible.

In the triple chute system as shown in FIG. 6, there are three wind blower outlets 96 of different sizes. Three lay-flat wind chutes 12 are connected to the wind blower outlets, which have same diameters to their corresponding wind blower outlets. The three wind chutes can share one wind blower 26 and a spare wind blower 28, or each wind chute can have its own independent wind blower. Each wind chute has its own exit opening 34, landing pad 32 and landing blower 30. The male-female connection with outside fasten band can be used to connect the wind chutes to the wind blower outlets. The ends of the lay-flat wind chutes 92 can be quickly connected to the wind blower outlets, fastened and air sealed by fasten bands 94 and fasteners 93. The lay-flat wind chutes are reinforced in the between by flexible cables 91 of metal fibers or polymer fibers. The flexible cables are engaged to the body of the landing unit 20 by hooks 90 and 95 to provide extra connection strength. The working principle of each wind chute is same as the single wind chute described in FIG. 1 and FIG. 7.

FIG. 7 shows the wind flows of the wind chute escape system. The wind blower 26 produces a high pressure airflow 27, which is injected into the center tube 25 via a series of jet pipes 24 to produce an upward wind pressure 23 (P₂₃). The landing fan 30 produces a strong vertical wind pressure 33 (P₃₃), which will dissipate in three routes: route 37 going out of the exit opening, route 35 going out of the top of the landing blower and route 39 creating a wind pressure (P₃₉) into the wind chute. The balance between the route 35 and route 39 is mainly controlled by the static pressure (Pₛ) inside the landing unit 20, which can be controlled by the air releaser 42 by releasing an airflow 41 back to the landing fan 30 or to the atmosphere outside. There is also some air loss through the rotating door 18.

The wind pressure P₂₃ and the wind pressure P₃₉ together form the upward wind pressure 15(P₁₅) inside the wind chute 12, i.e., P₁₅=P₂₃+P₃₉. This wind pressure P₁₅ is used to control the descending speed of the escapee inside the wind chute. Inside the wind chute there are mainly two forces acted on the descending body 14, the downward gravity and the upward wind pressure P₁₅. The balance of these two forces determines the descending speed of the escapee inside the wind chute. Since the wind pressure P₁₅ is under control, the descending body inside the wind chute can be controlled to a desired speed.

The wind pressure P₁₅ can be controlled in several means. First is to adjust the wind pressure P₂₃ by changing the speed of the wind blowing fan 26 or by a mechanical means, for instance, by closing or opening some of the jet pipes 24 to change the airflow rate into the wind chute, while keeping the wind pressure P₃₉ produced by the landing blower 30 to a predetermined value. Second is to adjust the wind pressure P₃₉ by changing the speed of the landing fan 30, or by changing the static pressure Pₛ inside the landing unit by the air releaser 42, while keeping the wind pressure P₂₃ produced by the wind blower to a predetermined value. Third is the combination of the first and second, where both of the wind pressure P₂₃ and P₃₉ are subjected to change to control the wind pressure P₁₅ inside the wind chute.

The win pressure P₃₃ provides the safe landing for the escapees. This wind pressure P₃₃ inside the landing blower is much stronger than the wind pressure P₁₅ inside the wind chute. Since the wind pressure P₁₅ is used to control the descending speed, it can not be too high to keep the escapees float inside the wind chute. The descending speed of the escapees should be high enough to achieve the desired evacuation rate. If the escapee is landed at such a descending speed, the landing may be too tough, or even cause landing injury. Thus, a much stronger landing pressure P₃₃ is used to decelerate the descending body inside the landing blower to a safe landing speed. The landing pressure P₃₃ and the landing path (height of the landing blower) are two key factors for the deceleration. The strength of the landing pressure P₃₃ is mainly determined by the landing fan 30. The balance between the landing pressure P₃₃ and the wind pressure P₁₅ is controlled by the static pressure Pₛ inside the landing unit 20. If the static pressure Pₛ is too high, much of the landing pressure P₃₃ is converted to the wind pressure P₁₅ via the wind pressure P₃₉, and the required balance between the landing pressure P₃₃ and the wind pressure P₁₅ will be lost.

The wind pressures discussed in this invention is dynamic pressures in fluid mechanic theory. The dynamic pressure is created by moving air, which is different from static air pressure. The relationships between the descending speed, the wind pressure, the escapee's body weight and the escapee's body size should be predicted with fluid mechanic theories.

A simple estimation is given here. Let W represent the downward gravity force, which equals the body weight of the descending escapee 14. Let F represent the upward force produced by the wind pressure, which equals the product of the wind pressure P₁₅ and the maximum section area S of the descending body, i.e., F=P₁₅×S. The maximum section area, S=πd²/4, where d is the maximum diameter of the descending body as shown in FIG. 7. When the downward gravity force equals the upward force produced by the wind pressure: W=F, the descending body will be float still inside the wind chute. Thus, we have, P₁₅=F/S=W/S=4W/πd². For example, the escapee 14 has maximum body diameter d=12 inches and weights W=150 pounds, the wind pressure P₁₅ required to keep the escapee float still inside the wind chute is about 1.33 pound per square inch (PSI). If the wind pressure is lower than 1.33 PSI, the escapee will descend inside the wind chute. If the wind pressure is higher than 1.33 PSI the escapee will be float still, or even fly upward. Thus, to control the wind pressure P₁₅ is an effect measure to control the descending speed of the escapee inside the wind chute. This is the principle of the present invention.

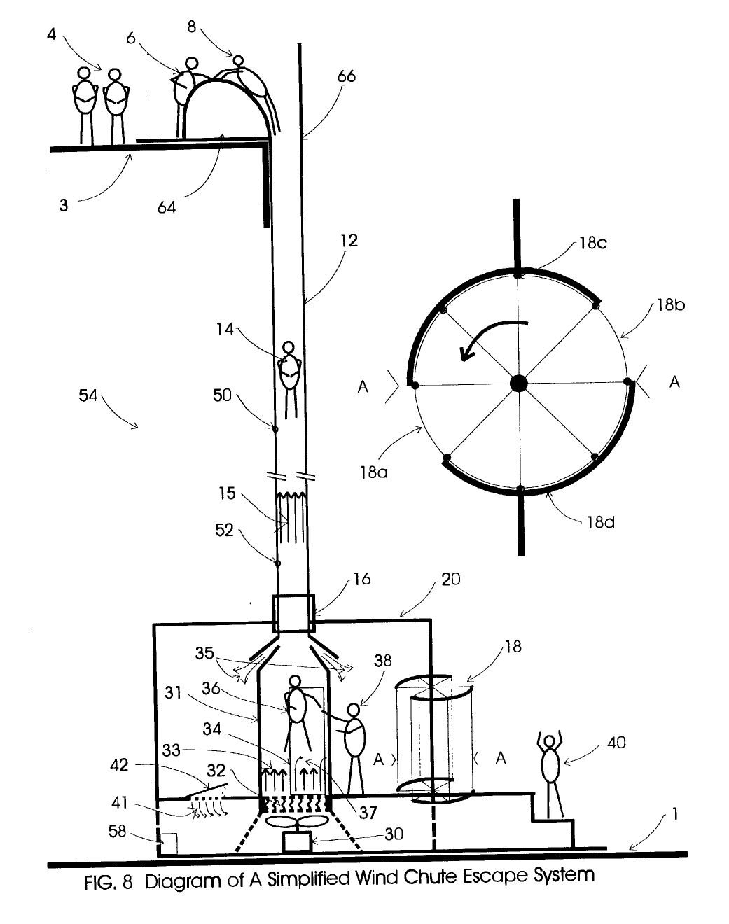

FIG. 8 shows a simplified embodiment of the present invention, which comprises a chute entrance 64, a wind chute 12, a rotating door 18, a landing blower 31 and an automatic control system 58 in the landing unit 20. In this wind chute escape system the landing fan 30 produces both of the landing pressure 33 inside the landing blower 31 and the wind pressure 15 inside the wind chute 12. The wind pressure 33 produced by the landing fan dissipates in three routes, route 37 going out of the exit opening 34, route 35 going of the top of the landing blower and route 15 going into the wind chute to create the wind pressure 15 to control the descending speed of the escapees inside the wind chute. The landing pressure 33 provides the safe landing for the escapee, which is much stronger than the wind pressure 15 in order to decelerate the descending speed of the escapee to a safe landing speed inside the landing blower. The airflow 35 and 37 create a static pressure inside the landing unit. The balance between the landing pressure 33 and the wind pressure 15 is controlled by the static pressure inside the landing unit 20. This static pressure can be controlled by the air releaser 42 by releasing an airflow 41 back to the landing fan 30 or to the outside atmosphere. Thus, the wind pressure 15 can be controlled by the static pressure inside the landing unit, or by changing the speed of the landing fan, or by a mechanical means to adjust the airflow rate into the wind chute.

The working principle of this simplified embodiment is the same as described in FIG. 1 and FIG. 7. All other components, such as, the chute entrance, the wind chute, the rotating door and the automatic control system are the same as described in FIG. 1. All four setup approaches, helicopter assisted setup, spool assisted setup, VTOL assisted setup and build-in setup, can be used in this simplified embodiment. The only limitation is that the balance between the landing pressure 33 and the wind pressure 15 can only be adjusted by the landing blower in the simplified embodiment.

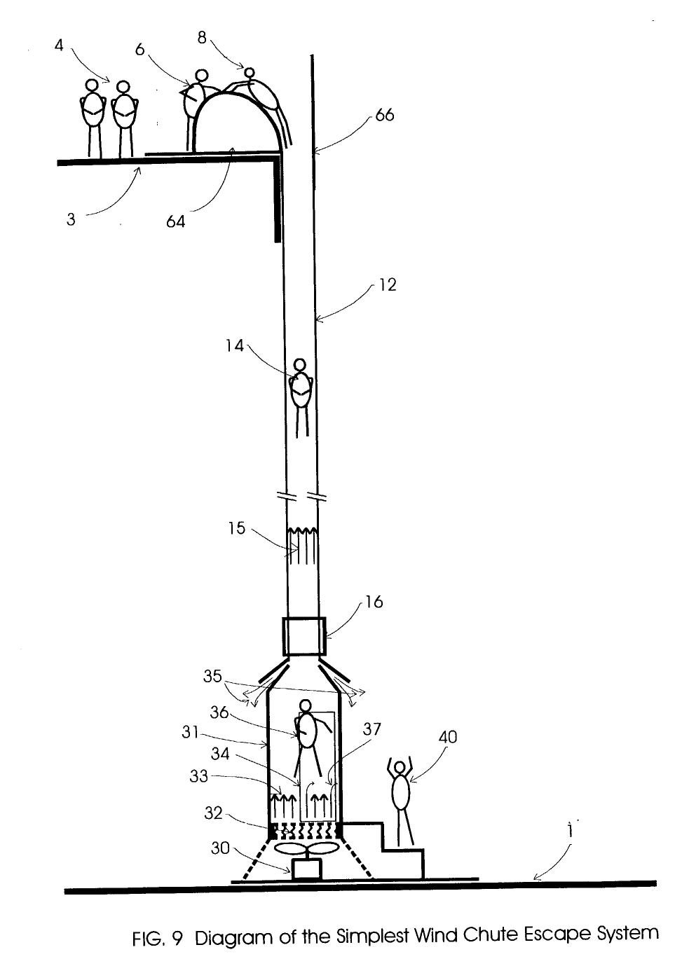

FIG. 9 shows the simplest embodiment of the present invention, which comprises a chute entrance 64, a wind chute 12 and a landing blower 31. In this wind chute escape system the landing fan 30 produces both of the landing pressure 33 inside the landing blower 31 and the wind pressure 15 inside the wind chute 12. The wind pressure 33 produced by the landing fan dissipates in three routes, route 37 going out of the exit opening 34, route 35 going out of the top of the landing blower and route 15 going into the wind chute to create the wind pressure 15 to control the descending speed of the escapees inside the wind chute. The landing pressure 33 provides the safe landing for the escapee, which is much stronger than the wind pressure 15 in order to decelerate the descending speed of the escapee to a safe landing speed inside the landing blower. The exit opening 34 can leave open or have some kinds of opening-closing mechanism to withhold some static pressure inside the landing blower 31. The balance between the landing pressure 33 and the wind pressure 15 can be adjusted in a limited range by changing the airflow rate of route 35, or by choosing the size of the exit opening 34, or by the opening-closing mechanism of the exit opening. Since there is no precise measure to control the wind pressure 15 and the balance between landing pressure 33 and the wind pressure 15, this simplest wind chute escape system can only be used for low-rise buildings or limited high-rise buildings.

The working principle of this simplest wind chute escape system is the same as described in FIG. 1 and FIG. 7. The chute entrance and the wind chute are the same as described in FIG. 1. All four setup approaches, helicopter assisted setup, spool assisted setup, VTOL assisted setup and build-in setup, can be used in this simplest wind chute escape system. A conventional used ladder fire truck or a crane truck can also be used to setup the wind chute escape system for low-rise buildings.

1. A wind chute escape system using a wind pressure to control the descending speed of a escapee inside a wind chute for emergency evacuation from high-rise structure or skyscrapers, comprises:
a chute entrance located or setup at an emergency floor level of a building where emergency evacuation required;
a group of wind chutes having two ends, one end is connected to said chute entrance and the other end is connected to a wind blower in a landing unit positioned on a safe ground;
a landing blower to produce an upward landing pressure to decelerate the descending body to a safe landing speed, and to create a wind flow into said wind chute;
a wind blower to produce a wind flow into said wind chute to wok together with said wind flow produced by said landing blower to create an upward wind pressure inside said wind chute to retard and control a descending body to a desired speed;
a rotating door installed on the outer shell of the landing unit to withhold a static pressure inside the landing unit for balancing said landing pressure inside said landing blower and said wind pressure inside said wind chute;
an automatic control system to sense the descending speed of the escapee and to control said wind pressure inside said wind chute to control the descending body to a desired speed, and to sense said wind pressures and said static pressure and control them to function as required;
and a means to setup said wind chute escape system, preferably a helicopter assisted setup, a spool assisted setup, a VTOL assisted setup and a build-in setup.

2. A wind chute escape system as defined in claim 1, wherein said upward wind pressure inside said wind chute is in a range from 0.1 PSI to 8 PSI, preferably, from 0.1 PSI to 5 PSI (Pound per Square Inch).

3. A wind chute escape system as defined in claim 2, wherein said upward wind pressure inside said wind chute is produced by said wind blower and said landing blower working together, or by one of them.

4. A wind chute escape system as defined in claim 2, wherein said upward wind pressure inside said wind chute is controlled by said wind blower by changing the speed of its wind blowing fan, or by a mechanical means to control the airflow rate into said wind chute while keeping said wind flow produced by said landing blower to a predetermined value.

5. A wind chute escape system as defined in claim 2, wherein said upward wind pressure inside said wind chute is controlled by said landing blower by changing the speed of its landing fan, or by changing said static pressure inside said landing unit while keeping said wind flow produced by said wind blower to a predetermined value.

6. A wind chute escape system as defined in claim 2, wherein said upward wind pressure inside said wind chute is controlled by said wind blower and said landing blower working together.

7. A wind chute escape system as defined in claim 1, wherein said wind chutes are flexible lay-flat tubes with diameters in a range from 1 to 8 feet, preferably, from 1 to 5 feet.

8. A wind chute escape system as defined in claim 7, wherein said lay-flat tubes are made of heavy duty fabrics or canvas, which provides strength exceeding safety requirements to withhold the wind pressure created inside of said lay-flat tube.

9. A wind chute escape system as defined in claim 7, wherein said lay-flat wind chutes are used in potable wind chute escape systems, such as, the helicopter assisted setup, the spool assisted setup and the VTOL assisted setup; in which said lay-flat wind chutes will be inflated by said wind pressure created inside of it, to be round hollow tubes ready for escapees descending through it.

10. A wind chute escape system as defined in claim 7, wherein said lay-flat wind chutes are preferred to be zigzag stored in a big box chute holder on the truck with an advantage that the wind chute can be pre-connected to the wind blower, or stored in a big spool-like frame chute holder.

11. A wind chute escape system as defined in claim 7, wherein the inside of said lay-flat tube is coated with a flexible polymer coating to provide air seal to the wind chute with the inside surface being smooth or coarse to be touched by a escapee with his hands or body to gain extra retardation or acceleration; while the outside of said lay-flat tube provides high mechanical strength, fire resistance and heat resistance.

12. A wind chute escape system as defined in claim 7, wherein said wind chutes are reinforced longitudinally with flexible cables of metal fibers or polymer fibers, which can provide strength exceeding the safety requirements to withhold the weight of the wind chute, the weight of the escapees descending inside the wind chute and the forces applied by the setup facility.

13. A wind chute escape system as defined in claim 7, wherein said wind chutes are made connectable from one to another by a flexible heavy duty zipper or by a male-female connection with an outside fasten band, so that different rescue height can be accomplished by connecting more wind chutes together; or said wind chutes are made in different length for different rescue heights.

14. A wind chute escape system as defined in claim 7, wherein said wind chutes can be grouped together in one setup, such as, double chute, triple chute, or multiple chute system, depending on the evacuation rate desired, in which said wind chutes can have same diameter or different diameters while different diameters are preferred if the body sizes of the escapees are considerably different.

15. A wind chute escape system as defined in claim 14, wherein each wind chute in a said multiple chute system can share one wind blower, or have its own independent wind blower and landing blower.

16. A wind chute escape system as defined in claim 1, wherein said wind chutes are rigid tubes with diameters in a range from 1 to 8 feet, preferably, from 1 to 5 feet.

17. A wind chute escape system as defined in claim 16, wherein said rigid tubes are made of plastic and metal materials by welding or other pipe forming technologies, which offer high mechanical strength and are preferred to be used for said permanent build-in setups.

18. A wind chute escape system as defined in claim 1, wherein said wind blower comprises at lest one wind blowing fan and one spare wind blowing fan, preferably, centrifugal fans, a series of jet pipes attached into a center tube, and a wind blower outer shell; while more than one wind blowing fan can be used side by side for more airflow or extra operation security, or in serial for higher wind pressure required.

19. A wind chute escape system as defined in claim 18, wherein said wind blowing fan produces a high pressure air flow jetting into said center tube via said jet pipes, in which said center tube has a diameter same as or larger than said wind chute connected to it.

20. A wind chute escape system as defined in claim 18, wherein said jet pipes are positioned in an angle to the center tube to produce a maximum upward wind pressure, where said angle is in a range from 1 degree to 90 degree, preferably, from 1 degree to 60 degree.

21. A wind chute escape system as defined in claim 18, wherein the number and size of said jet pipes must meet two requirements: allowing a total airflow rate high enough to create a wind pressure inside said wind chutes to control the descending speed of the escapees, allowing air pressure jetting into said center tube mild enough not to hurt the escapees when descending through said center tube.

22. A wind chute escape system as defined in claim 18, wherein said outer shell, center tube and jet pipes are made of plastic and metal materials by molding, welding or other forming technologies.

23. A wind chute escape system as defined in claim 1, wherein said landing blower comprises at least one landing fan, preferably, an axial fan, a landing pad, an exit opening and a landing blower outer shell, while more than one landing fan can be used in serial to increase required wind pressure or operation security.

24. A wind chute escape system as defined in claim 23, wherein said landing fan produces a strong upward wind pressure to decelerate the descending body to a safe landing speed inside the landing blower, and to create a wind pressure into said wind chute to work together with said wind pressure produced by said wind blower to create an upward wind pressure inside said wind chute to control the descending speed of the escapees.

25. A wind chute escape system as defined in claim 23, wherein said landing pad comprises a series of springs, a top mesh, a bottom mesh and a vibration reducer apparatus, which provides softer landing without bouncing-up, and has little resistance to the wind flow produced by said landing fan.

26. A wind chute escape system as defined in claim 1, wherein said chute entrance is made of plastic and metal materials, which can be a regular sliding type, a facing-down sliding type, or even a holding bar to let the escapees easily and quickly enter said chute entrance; ready to be fastened to the emergency floor level; and to provide solid safe guard for the escapees.

27. A wind chute escape system as defined in claim 1, wherein said rotating door is installed on the outer shell of said landing unit, which is surrounded by two large air tight walls and heavy duty air seals around it to withhold said static pressure inside said landing unit.

28. A wind chute escape system as defined in claim 1, wherein said landing unit consists of said wind blower, said landing blower, said rotating door, said automatic control system and an outer shell, which has holes and air filters on its top section for the air intake of said wind blower, and has holes and air filters on its bottom section for the air intake of said landing blower .

29. A wind chute escape system as defined in claim 28, wherein said landing unit has an air releaser to control said static pressure inside said landing unit to balancing said landing pressure in said landing blower and said wind pressure in said wind chute by releasing an airflow back to said landing fan or to the outside atmosphere.

30. A wind chute escape system as defined in claim 1, wherein said helicopter assisted setup comprises a helicopter, a truck containing said landing unit, said lay-flat wind chute and said chute entrance, which works as follows:
said helicopter uses a long cable to pick up said chute entrance together with said wind chute from said truck, and lifts said chute entrance to the emergency floor level;
said chute entrance is quickly fastened to the emergency floor level and at the same time the other end of said wind chute is connected to said landing unit on said truck;
when said landing unit is started to produce said wind pressure into said wind chute, said lay-flat wind chute will be inflated under said wind pressure;
said wind pressure is transferring from said landing unit up to said chute entrance along said wind chute; there will be a strong wind flow blowing out of said chute entrance;
when said upward wind pressure reaches a predetermined strength, the system is ready for people to escape through said wind chute.

31. A wind chute escape system as defined in claim 1, wherein said spool assisted setup comprises a truck containing said landing unit and said wind chute; and a movable cart containing said chute entrance and a spool and positioned at an escape opening at the emergency floor level of the building; which works as follows:
said truck is positioned on a safe ground beside the building in a emergency situation;
said spool and a cable located on the emergency floor level are used to pull said wind chute to said chute entrance, and is quickly connected to said chute entrance;
said landing unit is started to produce said wind pressure into said wind chute;
said lay-flat wind chute will be inflated by said upward wind pressure; when it reaches a predetermined strength, the system is ready for the people to escape through said wind chute.

32. A wind chute escape system as defined in claim 1, wherein said VTOL assisted setup has a complete wind chute escape system installed on a truck, comprising said landing unit, said lay-flat wind chute zigzag stored in a chute holder and said VTOL device with a build-in chute entrance; which works as follows:
said truck is positioned beside the building in an emergency situation; said VTOL device takes off from said truck and pulls said wind chute to the emergency floor level;
said VTOL device provides a means to hold in position to the escape opening;
when said landing unit is stared and the system is ready, people get on said VTOL device from the escape opening, enter said wind chute through said chute entrance and descend to the safe ground.

33. A wind chute escape system as defined in claim 1, wherein said build-in setup is a complete wind chute escape system permanently built inside or outside of the building, in which said landing unit is located on the ground level, said rigid wind chutes are built as high as the building and a series of chute entrances are located on several floor levels of the building.

34. A wind chute escape system as defined in claim 33, wherein one set of said wind chutes is devoted to one floor level where chute entrances are installed; or one set of said wind chutes is shared by several floor levels, in which chute entrances are installed on several floor levels; and said chute entrances have air tight doors to be closed when said chute entrances are not used or when somebody is descending above this floor level.

35. A wind chute escape system as defined in claim 33, wherein said build-in setup can be used for practice to use said wind chute escape system; or used as an alternation of elevators; or used as an amusement device while not in emergency situations.

36. A wind chute escape system as defined in claim 1, wherein said wind chute escape system is simplified to have only one landing blower in said landing unit, in which said landing blower produces both of said landing pressure inside said landing blower to decelerate the descending body to a safe landing speed and said wind pressure inside said wind chute to control the descending speed of the escapees.

37. A wind chute escape system as defined in claim 36, wherein said landing pressure inside said landing blower and said wind pressure inside said wind chute, as well as their balance are controlled by said static pressure inside said landing unit, or by changing the speed of said landing fan, or by a mechanical means to control the airflow rate into said wind chute.

38. A wind chute escape system as defined in claim 36, wherein said simplified wind chute escape system can be setup as said helicopter assisted setup, said spool assisted setup, said VTOL assisted setup or said build-setup.

39. A wind chute escape system as defined in claim 1, wherein said wind chute escape system is reduced to its simplest embodiment, comprising only one landing blower, and said chute entrance and said wind chute, in which said landing blower produces both of said landing pressure inside said landing blower to decelerate the descending body to a safe landing speed and said wind pressure inside said wind chute to control the descending speed of the escapees.

40. A wind chute escape system as defined in claim 39, wherein said landing pressure inside said landing blower and said wind pressure inside said wind chute, as well as their balance are controlled in a limited range by changing the airflow out of the top of said landing blower, or by choose the size of the exit opening on said landing blower, or by a closing-opening mechanism of the exit opening on said landing blower.

41. A wind chute escape system as defined in claim 39, wherein said simplest wind chute escape system can be setup as said helicopter assisted setup, said spool assisted setup, said VTOL assisted setup and said build-in setup, or setup by a conventional ladder fire truck or a crane truck for low-rise buildings.
